(19) United States
(12) Patent Application Publication
(10) Pub. No.: US 2005/0014856 A1
(43) Pub. Date: Jan. 20, 2005

(54) Non-halogenated phosphate anti-scorch additive for polyurethane foam

(76) Inventors: Barbara A Williams, New York, NY (US); Danielle A. Bright, New City, NY (US); Emanuel Pinzoni, Hawthorne, NY (US)

Correspondence Address: DILWORTH & BARRESE, LLP, 333 EARLE OVINGTON BLVD., UNIONDALE, NY, 11553, US

(21) Appl. No.: 10/498,472

(22) PCT Filed: Dec. 19, 2002
(86) PCT No.: PCT/US02/40750

Related U.S. Application Data
(60) Provisional application No. 60/342,325, filed on Dec. 21, 2001.

(51) Int. Cl. C08G 18/00

(52) U.S. Cl. 521/155

(57) ABSTRACT

Non-halogen, flame-retardant polyurethane foam compositions having reduced discoloration or scorch during their manufacture contain an effective amount of a flame retardant of the formula: where Ar is an aryl or an alkaryl group, R is neopentylene, and the average value of n is 1 to 10.

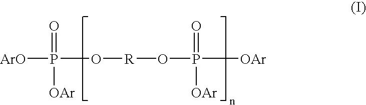

This application claims priority from U.S. Provisional Patent Application No. 60/342,325, filed Dec. 21, 2001.

Polyurethane foams are made by polymerization of aromatic isocyanates and aliphatic polyols. The process involves simultaneous polymerization and expansion by blowing agents, such as chlorofluorocarbons (CFCs). Because this process is highly exothermic, it causes the development of scorch, which is an undesirable discoloration in the center of a flexible polyurethane foam bun. Efforts to reduce the use of CFC blowing agents for foaming by increasing the water content lead to higher exotherms and therefore increased scorch potential. In addition to the reduction of aesthetic value, scorch adversely affects key physical properties, such as tensile and tear strength, elongation, and compression set.

During commercial flexible polyurethane foam processing, scorching may occur in the center of the foam buns. This scorching is usually observed when the bun is cut open about one hour after reaching its maximum exotherm. The propensity to scorch escalates with increasing exotherm temperature, which in turn is dependent on the water level used in the formulation. As the water level is increased from 3.5 to 5.0 parts per hundred (“php”), based on the weight of polyol, the exotherm may increase from 130° C. to 170° C. or even higher (the so-called “foam line temperature”). The susceptibility to discoloration of the foam buns is increased by the addition of certain flame retardants, for example, haloalkyl phosphates, into the formulation.

Therefore, combining a high water level with a haloalkyl phosphate in the foam formulation can promote scorch more readily. A 3.5 php water level is less likely to induce scorch even with a flame retardant present. A water level of 5.0 php plus flame retardant is very likely to produce scorch.

Due to the low thermal conductivity of flexible foams, heat tends to buildup within the foam structure. This seems to happen more readily in high water formulations and with the use of auxiliary blowing agents. Scorch that usually occurs at the center of the foam is most likely to occur in slabstock foams.

To assess the scorch potential of various flame-retardants, a laboratory scale test that correlates well with actual foam production employs microwave radiant energy as described in U.S. Pat. No. 4,131,660. In this method, the microwave energy heats a flexible polyurethane foam thereby increasing the internal temperature of the foam. This test is used with laboratory scale foams, in particular, since such small foams allow for rapid dissipation of heat so that any scorching or discoloration of the foam is usually minimal or undetectable (see Col. 1, lines 26-32 of U.S. Pat. No. 4,131,660). The microwave test is therefore a convenient way of interrogating laboratory size foams to determine their likely susceptibility to scorching when and if they are scaled up to commercial size.

The addition of flame retardants increases the level of scorch produced in the foam. A number of approaches have been used to reduce scorching. In U.S. Pat. No. 5,182,193 to Dow Chemical, hindered phenolic anti-oxidants are used for that purpose. U.S. Pat. No. 5,422,415 to Ciba Geigy describes a combination of a benzofuranone additive, an amine anti-oxidant and a hindered phenolic. Vitamin E (alpha or beta tocopherol) together with octyl diphenyl amine is described by Bayer in U.S. Pat. No. 5,695,689 to ameliorate scorching. Rhein Chemie Rheinau describes the use of an aromatic carbodiimide and a benzohydroquinone to prevent polyester urethane discoloration and reduce hydrolytic degradation in U.S. Pat. No. 5,130,360. All these approaches result in an improvement in the appearance of the foam.

More recently, Japanese Patent No. 2882724 to Daihatsu Kagaku Kogyo K. K. describes a composition for use in low fogging flame-retardant polyurethanes that comprises an organophosphorus compound of the formula: 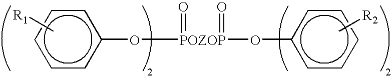
wherein R₁ and R₂ represent identical or different lower alkyl group or hydrogen atoms and Z represents any of the structures that follow: 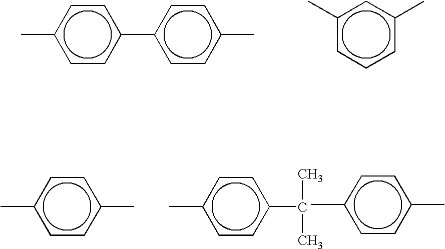
—CH₂—CH₂—; or —CH₂CH₂OCH₂CH₂—CH₂—. This patent refers to the fact that these types of products can suppress scorching inside the foams.

Akzo Nobel Functional Chemicals makes the FYROL PBR brand flame retardant, which is a blend of pentabromodiphenyl oxide and a proprietary mixture of aromatic phosphates. This product gives very low scorch. However, brominated diphenyl oxides, especially pentabromodiphenyl oxides are believed to bioaccumulate and therefore their use may present perceived environmental problems.

The present invention relates to solving the drawbacks of the prior art and to provide a novel non-scorching polyurethane foam containing a particular type of non-halogen, non-scorching phosphate flame-retardant.

A further object of this invention is to provide a phosphate flame-retardant, which, while imparting excellent flame retardancy and low scorch behavior, is further characterized by superior chemical and physical properties, such as stability and low acidity, so as to yield foams having white color (at maximum very low scorching), no odor, and generally good physical properties.

Accordingly, the present invention provides a polyurethane foam composition comprising an organic phosphorus compound of formula (1): 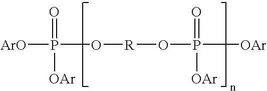
wherein Ar is an aryl (such as phenyl) or an alkaryl group, R represents a neopentylene, and the average value of n is from 1 to about 10, preferably from about 1 to 5. While U.S. Pat. No. 5,958,993 describes the use of this compound, among others, as an additive to polyurethane foams for low fogging characteristics, the laboratory scale foams that were exemplified in that patent did not show any scorching behavior for that additive as earlier explained (see Col. 1, lines 26 to 32 of U.S. Pat. No. 4,131,660).

The present invention is further illustrated by the Examples that follow.

### EXAMPLES

Formulation

| | | |
|---|---|---|
| F3020 polyether polyol | 100 | 100 |
| Flame retardant | 12 | 12 |
| DABCO 33LV/A-1 (3:1 amine catalyst) | 0.20 | 0.22 |
| H₂O | 3.50 | 5.00 |
| L620 silicone | 1.20 | 1.00 |
| Stannous octoate T-10 | 0.40 | 0.30 |
| Toluene diisocyanate (TDI) | 46.6 | 60 |
| NCO index | 110 | 110 |

The polyol, flame-retardant, water, amine catalyst and silicone were mixed, with stirring, in a first beaker. In a separate beaker, the toluene diisocyanate (TDI) was weighed out. The organo-tin catalyst was put into a syringe. The first beaker was stirred at 2100 revolutions per minute for a period of ten seconds and then the organo-tin catalyst was dosed thereto while stirring was continued. After a total of about twenty seconds of stirring, the TDI was added to the mixture. Stirring was then continued for about an additional ten seconds, the still fluid mixture was quickly put into an 8″×8″×5″ box, and then the cream and rise time was measured. Once the foam ceased to rise, it was placed in a microwave oven thirty seconds thereafter for eighty seconds.

Microwave Oven Test

The amount of scorch in the foam was measured according to “A Rapid Predictive Test for Urethane Foam Scorch”, Journal of Cellular Plastics, September/October 1978 and U.S. Pat. No. 4,131,660. This method employs a microwave oven as a tool to cure and heat the inner core of the polyurethane foam. The foams were formulated at high/low water levels. This method has been said to be equivalent to large slabstock foams. After the foams were cooled for twenty-four hours, they were cut in the center and the discoloration was measured with a Minolta spectrophotometer (model # CM-500d). The delta Lb measures the yellowness in the foam. The human eye cannot detect the differences the spectrophotometer machine can evaluate. The visual rating represents a number from 1 to 5. A value of 1 is assigned to a white foam showing no discoloration, whereas a value of 5 would represent a very dark foam. The foams produced at 3.5 pph revealed no or low scorch at the center. Neopentyl glycol bisdiphenyl phosphate (“NDP” in the following table, with “NFR” indicating “no flame retardant”) is a flame retardant producing very low discoloration at 5 pph of water.

| | | | Visual |
|---|---|---|---|
| Sample | Level of FR | Lb* | Rating |
| Water at 3.5 pph | | | |
| NFR | 0 | 1.06 | 1.0 |
| NDP | 12 | 0.87 | 1.0 |
| FYROL ® FR-2 | 12 | 1.42 | 1.2 |
| FYROL ® PBR | 12 | 1.29 | 1.0 |
| Water at 5.0 pph | | | |
| NFR | 0 | 0.13 | 1.0 |
| NDP | 12 | 0.83 | 1.5 |
| FYROL ® FR-2 | 12 | 17.88 | 3.0 |
| FYROL ® PBR | 12 | 0.17 | 1.5 |

*Lb: a lower number indicates less color

Water Level

A higher amount of water in a formulation creates large exotherms that also create a climate to produce scorch. Two formulations using two levels of water: 3.5 pph and 5.0 pph were run, and it was found that the formulations produced at 5.0 parts of water in some cases produced scorch and that use of the lower levels of water at 3.5 parts did not. The internal temperatures of the two water levels were measured with a FORMAT machine using a light sensor. The foams were prepared and a hole was placed 2.5” from the bottom midway in the 12″×12″×5″ box. The probe was inserted and left for ten minutes. The chart below demonstrates that an increase in the water formulation produces higher internal temperatures by a factor of 40-50° F. degrees.

| | | Internal | |
|---|---|---|---|
| Sample | Level of FR | Temp. ° F. | ° C. |
| Water at 3.5 pph | | | |
| NFR | 0 | 238° F. | 115 |
| NDP | 12 | 237 | 114 |
| FYROL ® FR-2 | 12 | 228 | 109 |
| FYROL ® PBR | 12 | 245 | 119 |
| Water at 5.0 pph | | | |
| NFR | 0 | 279° F. | 137 |
| NDP | 12 | 284 | 140 |
| FYROL ® FR-2 | 12 | 283 | 140 |
| FYROL ® PBR | 12 | 290 | 144 |

The following Table illustrates a differing comparative run indicating that the NDP additive used in accordance with this invention provided a slightly higher Lb rating higher in color than produced by using bisphenol A bis(diphenyl phosphate) or “BDP”. The visual rating to the eye is very close and the samples were relatively low in discoloration.

| | Level of | | |
|---|---|---|---|
| Sample | FR | Lb* | Rating |
| Water @ 5.0 pph | | | |
| NDP | 14 | 1.6 | 1.5 |
| FYROLFLEX ® BDP | 14 | 3.4 | 1.5 |

*Lb-the lower the number indicates less color

The foregoing, which only describe certain embodiments of the present invention, should not be construed in a limiting sense for that reason. The scope of protection sought is therefore set forth in the Claims that follow.

1. A non-halogen, flame-retardant polyurethane foam composition having reduced discoloration or scorch during its manufacture comprising an effective amount of a flame retardant of the formula: 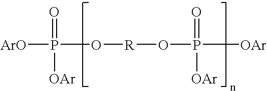
where Ar is an aryl or an alkaryl group, R is neopentylene, and the average value of n is 1 to 10.

2. The composition of claim 1 wherein the average n value of the phosphate flame retardant is from 1 to about 5.

3. The composition of claim 1 wherein the flame retardant is neopentylene glycol bis(diphenyl phosphate).

4. The composition of claim 3 wherein the average n value of the phosphate flame retardant is from 1 to about 10.

5. The composition of claim 3 wherein the average n value of the phosphate flame retardant is from 1 to about 5.

6. The composition of any of claims 1-5 where Ar is phenyl.
